(19) United States
(12) Patent Application Publication
(10) Pub. No.: US 2020/0391334 A1
(43) Pub. Date: Dec. 17, 2020

(54) CHANGE DEVICE FOR CHANGING OF TOOLS AND/OR WORKPIECES

(71) Applicant: Gebr. Heller Maschinenfabrik GmbH, Nuertingen (DE)

(72) Inventors: Eric SEEMAIER, Nuertingen (DE); Achim WOHLFAHRT, Dettingen (DE)

(21) Appl. No.: 16/897,973

(22) Filed: Jun. 10, 2020

(30) Foreign Application Priority Data
Jun. 11, 2019 (DE) 102019115715.3

(51) Int. Cl. B23Q 3/155

(52) U.S. Cl. CPC B23Q 3/1554; B23Q 2003/155428; B23Q 2003/155418; B23Q 2003/155411

(57) ABSTRACT

A change device for changing or exchanging of tools and/or workpieces. The change device has a gripper device with at least one gripper arm that extends away from a rotation support body that is rotatably supported about the rotation axis and that has a holder for respectively one tool or one workpiece at its free end. By means of a rotary power train with a rotary drive motor and a rotary drive transmission, the gripper device can be rotated about the rotation axis. Particularly the rotary drive transmission has a belt gear. A first rotary position sensor is directly or indirectly coupled with the rotation support body and/or transmission output of the rotary drive transmission without interconnection of the rotary drive transmission for detection of the rotary position of the gripper device about the rotation axis.

### CROSS REFERENCE TO RELATED APPLICATIONS

This application claims priority under 35 U.S.C. § 119 to the following German Patent Application No. 10 2019 115 715.3 filed on Jun. 11, 2019, the entire contents of which are incorporated herein by reference thereto.

### BACKGROUND

The invention refers to a change device that is configured to change tools and/or workpieces. The change device is configured for use with a machine tool with automatic tool change or workpiece change and can be integrated in the machine tool or can be arranged at or adjacent to the machine tool as separate unit.

Such a change device is, for example, known from EP 1 525 945 B1 or EP 1 013 373 B1. The change device comprises a gripper device with two holders for a tool to be exchanged. The gripper unit is arranged at a shaft that extends along a rotation axis. By means of a rotational drive the shaft can be moved around the rotation axis. Thus, the gripper device is rotationally supported together with the shaft around the rotation axis.

Such change devices have to be able to execute a change of a tool or workpiece very quickly. Thus, high rotational accelerations or rotational speeds are necessary. On the other hand, due to the configuration of the power train, the dynamic is limited. In a rotary power train oscillations or vibrations can occur in case of too high accelerations due to elasticities such that the positioning of the gripper device in a desired rotational position about the rotation axis is difficult. Difficulties are increased, because the load of the gripper can be very different. In case of grippers with several holders for several tools or workpieces a different number of workpieces or tools can be held. In addition, the weight of the load can lead to relatively large torques about the rotation axis due to the weight force of the at least one held tool or workpiece. The resulting torque that is created by the gripper device about the rotation axis depends on the relative position of the connecting line between the holder and the rotation axis relative to the vertical or horizontal and thus depends on changes during the progress of a rotational movement. The load can also be asymmetrical. These influences have to be considered for the control of the change device.

Additional constraints for the change device that have to be considered are on one hand the costs and on the other hand the required space. The space required by the rotary power train should not limit the length of the tool or workpiece that can be held in a holder and can be changed in a machine tool. In addition, the cantilever extension of a machine spindle in which the tool or workpiece can be inserted, originating from a rigid support structure, should be as short as possible in order to achieve a high rigidity and thus a high precision of the machine tool, which is another constraint to be considered for designing of the rotational power train. For these reasons it is often not possible to directly arrange the rotational drive motor of the rotary power train directly at and in extension of the rotation axis.

### BRIEF DESCRIPTION

Thus, it can be considered as object of the present invention to provide a change device that ensures a high positioning precision of the rotational position of the gripper device about the rotation axis, also in case of a high dynamic and large masses of the tools or workpieces to be changed.

A change device that is configured for changing tools and/or workpieces, including: a gripper device that is rotatably supported about a rotation axis at a rotation support body, the gripper device having at least one holder for a tool and/or a workpiece to be held, a rotary power train that is configured to rotate the gripper device about the rotation axis, wherein the rotary power train comprises a rotary drive motor and a rotary drive transmission, wherein the rotary drive motor is drivingly coupled with a transmission input of the rotary drive transmission and wherein transmission output of the rotary drive transmission is drivingly connected with the rotation support body, a first rotary position sensor that is coupled with the rotation support body without interconnection of the rotary drive transmission, wherein the first rotary position sensor is configured to detect a rotary position of the gripper device about the rotation axis.

The change device is configured for change or exchange of tools and/or workpieces. It comprises a gripper device that is rotationally supported about a rotation axis on a rotation support body. The rotation support body can consist of one single integral part or can be assembled of multiple parts connected with each other. The gripper device has at least one holder with distance to the rotation axis and in a preferred embodiment two holders that are arranged diametrically opposed with reference to the rotation axis, each provided for a tool or a workpiece to be gripped.

A rotary power train is configured to rotate the gripper device about the rotation axis. The rotary power train comprises a rotary drive motor and a rotary drive transmission having a transmission input and a transmission output. The rotary power train establishes a drive connection between the rotary drive motor with the rotation support body via the rotary drive transmission. The rotary drive motor is drivingly connected with the transmission input of the rotary drive transmission and the rotation support body is drivingly connected with the transmission output of the rotary drive transmission. Particularly, the transmission output can be aligned with the rotation axis and the transmission input can be arranged with distance radial to the rotation axis.

A first rotary position sensor of the change device is configured to detect the rotary position about the rotation axis of the gripper device and particularly the rotary position about the rotation axis of the at least one holder. A respective sensor signal can be provided to a control device for controlling the rotary drive motor, in order to be able to exactly position the tool or workpiece provided in the at least one holder during an automatic change. For detection of the actual rotary position of the rotation support body about the rotation axis, the first rotary position sensor is coupled with the rotation support body without interconnection of the rotary drive transmission. At least one rotatable sensor part of the first rotary position sensor is rotationally movably coupled with the rotation support body and rotates substantially without load, particularly independent from the load of the rotary power train, very precisely depending on the rotation movement of the rotation support body about the rotation axis. Large and varying forces and torques are effective in the rotary power train depending on the occurring rotational accelerations of the rotary drive motor and depending on the actual load of the gripper device, as well as the actual rotary position of the rotation support body or the gripper device about the rotation axis. Due to elasticities in the rotary drive transmission, deviations between the actual rotational position of the motor and the actual rotational position of the gripper device about the rotation axis can occur. These deviations have to be eliminated or considered during the control of the rotary drive motor during a change process in order to be able to exactly position the gripper device and to avoid damages of the machine tool and the tools or workpieces. According to the invention, the first rotary position sensor is thus coupled with the rotation support body for detection of the rotary position by bypassing the rotary drive transmission and can be coupled directly with the rotation support body or indirectly via at least one substantially load-free coupling element with the rotation support body in a non-torque-proof manner. The position detected by the first rotary position sensor thus corresponds very precisely with the actual rotary position of the gripper device about the rotation axis. Thus, the rotary position detection is independent from the load, the acceleration of the rotation movement of the gripper device and other external influences of the rotary power train. By means of the first rotary position sensor an exact control of the rotary position of the gripper device about the rotation axis can be carried out.

Due to the rotary drive transmission, the rotary drive motor can be arranged axially offset from the rotation axis in order to achieve a more compact construction of the change device. Particularly, a required space in the region of the rotation axis is reduced such that a spindle cantilever extension at the machine tool that is as low as possible and thus a high rigidity and accuracy of the machine tool can be achieved. In addition, axial lengths of the tools or workpieces to be exchanged are not limited. Overall a compact configuration with optimized required space of the exchange tool can be achieved.

In a preferred embodiment a rotatable sensor part of the first rotary position sensor is directly and torque-proof connected with the rotation support body, such that the rotationally supported sensor part rotates together with the rotation support body about the rotation axis. In another embodiment the rotatably supported sensor part of the first rotary position sensor can be coupled with the rotation support body via at least one coupling element. The at least one coupling element can be a gear and particularly a belt gear with a belt and two pulleys for example. In this case, the belt gear does not form part of the rotary drive transmission, but is independent therefrom.

The rotary drive transmission can particularly comprise a belt gear. The belt gear has a belt that is guided around at least two pulleys. Preferably one pulley is in coaxial alignment with the rotation axis and the other pulley is arranged with a radial distance to the rotation axis. In the simplest case the rotary drive transmission can consist of one belt gear. The rotary drive transmission is then configured as belt transmission. A belt gear is cheap and only requires low space. The influence of the elasticity that is present, due to the belt gear in the belt transmission, is reduced or eliminated during the control or feedback control of the rotary position of the gripper device about the rotation axis, because the actual rotary position is detected via the first rotary position sensor, independent from the elasticity of the rotary drive transmission. In doing so, a precise rotary position feedback control can be achieved, even if a belt gear is provided.

The change device preferably comprises a control device to which the sensor signal of the first rotary position sensor is supplied and that is configured to control the rotary drive motor. In doing so a feedback loop for feedback control of the rotary position of the gripper device about the rotation axis can be realized.

In a preferred embodiment the rotary power train comprises an additional sensor that detects an actual rotary position of a part in a rotary power train between the rotary drive motor and the transmission input or the belt gear. Between the first rotary position sensor and the additional sensor the belt gear of the rotary drive transmission is interconnected according to an embodiment. Particularly the additional sensor can be a motor sensor that is arranged in or at the rotary drive motor and is configured to detect the actual rotary position of the rotary drive motor about a motor axis. A sensor signal characterizing the actual rotary position of the rotary drive motor can be supplied to the control device. The additional sensor can be alternatively arranged also at another location between the rotary drive motor and the transmission input of the rotary drive transmission. Failures in the rotary drive transmission can be determined, because in this embodiment a sensor signal is present that characterizes a rotary position at the transmission input and a sensor signal is provided that characterizes the rotary position at the transmission output or at the rotation support body. Based on the amount and/or the time-dependent progress of the two sensor signals, it can be determined, e.g. if a belt in the rotary drive transmission ruptured or if the belt condition is insufficient to guarantee a slip-free transmission of torques between the pulleys.

In addition, the control device can be configured to determine the weight of a tool or workpiece that is present in the at least one holder of the gripper device. The weight of the tool or workpiece in the holder is characteristic for the difference in the amount and/or the time-dependent progress of the sensor signal of the additional sensor at the transmission input and the sensor signal of the at least one rotary position sensor that is coupled with the rotation support body. By a comparison of these two sensor signals the mass or weight of the tool or workpiece that is present in the holder can be determined. Alternatively or additionally, in a gripper device that comprises two holders, the difference of the weights of the tools or workpieces that are present in the two holders can be determined.

It is also advantageous, if in addition to the rotary power train a shift power train is provided. The shift power train is configured to create a stroke or linear movement of the gripper device along or parallel to the rotation axis. In doing so, the insertion in or the removal out of a holding fixture or spindle of the machine tool of a tool or workpiece can be carried out for example.

The shift power train can comprise a shift drive transmission with a transmission input and a transmission output. The transmission input of the shift drive transmission is drivingly coupled with a shift drive motor and the transmission output is drivingly coupled with a threaded spindle. At the threaded spindle a spindle nut can be arranged. In case of rotation of the threaded spindle, a movement of the spindle nut along or parallel to the rotation axis can be carried out. Particularly, the spindle nut can be movably connected with the rotation support body or can be integral part of the rotation support body. The spindle nut is preferably not movably relative to the rotation support body, neither along or parallel to the rotation axis nor in circumferential direction about the rotation axis. With reference to the transmission output of the rotary drive transmission the spindle nut is preferably supported in a torque-proof manner and only shiftably supported parallel or along the rotation axis.

Analog to the rotary power train also the shift power train can comprise at least one sensor or rotary position sensor. Preferably a second rotary position sensor is present that is coupled with the threaded spindle without interconnection of the shift drive transmission. The second rotary position sensor is configured to detect the rotation movement and/or the rotary position of the threaded spindle about the rotation axis and to create a characterizing sensor signal. This sensor signal can be submitted to the control device.

In addition, it is advantageous, if the shift power train comprises an additional sensor that can be configured as motor sensor for example. This additional sensor is configured to create a sensor signal that is characteristic for the rotary position of the transmission input of the shift drive transmission. The sensor signal can be supplied to the control device.

The control device can compare the sensor signal of the second rotary position sensor and the additional sensor of the shift power train and can determine a malfunction of the shift drive transmission in a manner analog to the rotary power train. If the shift drive transmission comprises, e.g. a belt gear, the rupture of a belt of this belt gear can be determined.

In a preferred embodiment the rotary drive transmission comprises a transmission housing. In the transmission housing the first rotary position sensor and/or the second rotary position sensor can be arranged. In doing so, the first and/or second rotary position sensor is protected from damages and/or contamination due to chips or cooling media.

In a preferred embodiment the gripper device comprises multiple holders and particularly two holders each provided for one tool or workpiece. The gripper device can comprise at least one gripper arm extending away from the rotation support body orthogonal to the rotation axis. At the free end of each gripper arm opposite to the rotation support body one holder can be provided. In a preferred embodiment the gripper device is configured as double gripper and thus comprises two gripper arms that can extend along a common straight line and can be arranged diametrically with reference to the rotation axis.

Preferred embodiments of the invention yield from the dependent claims, the description and the drawings.

### BRIEF DESCRIPTION OF THE FIGURES

In the following preferred embodiments of the invention are explained in detail with reference to the attached drawings. The drawings show:

FIG. 1 a perspective view of an embodiment of a change device,

FIG. 2 a schematic block-diagram-like illustration of an embodiment of a change device,

FIG. 3 a schematic block-diagram-like illustration of an embodiment of a change device,

FIG. 4 a schematic block-diagram-like illustration of an embodiment of a rotary position sensor and

FIGS. 5-8 each are a schematic illustration of a spindle of a machine tool and a change device in different states during execution of a tool change.

### DETAILED DESCRIPTION

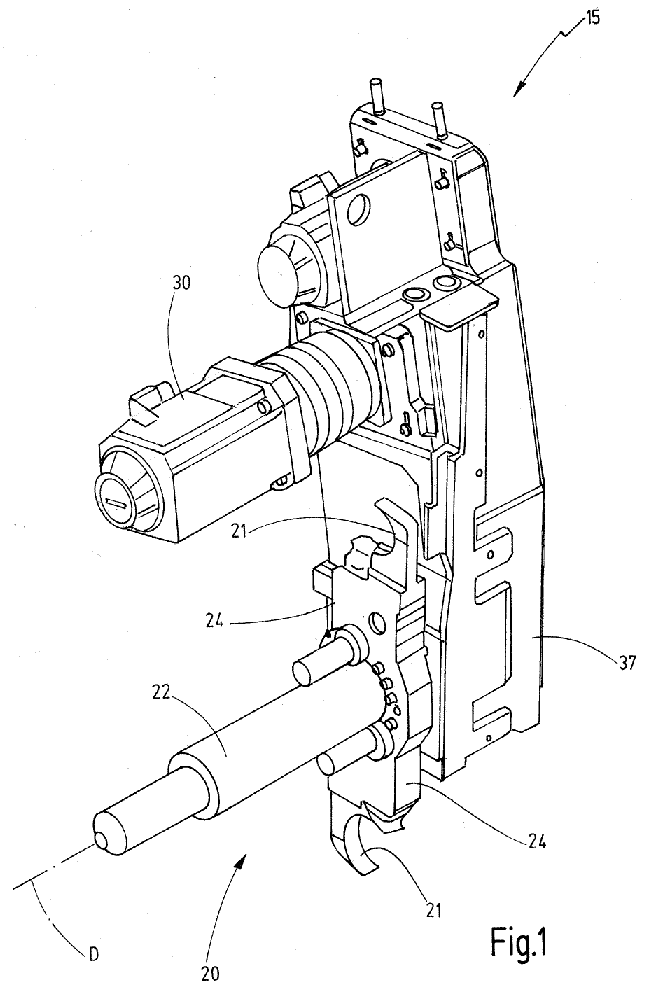

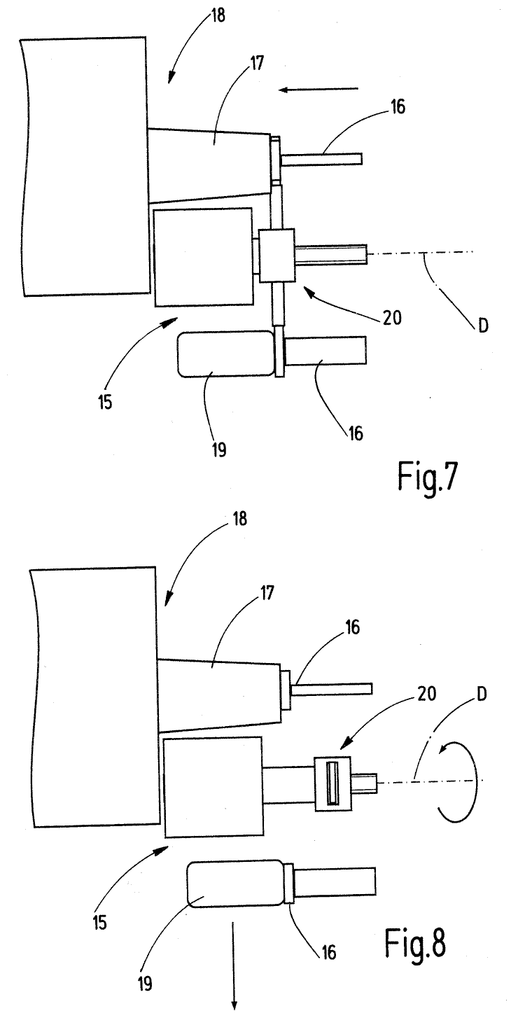

FIG. 1 shows a change device 15 according to the invention that is configured to automatically change or exchange a tool 16 (FIGS. 5-8). In the embodiment the change device 15 is configured to insert or remove different tools 16 in or from a spindle holding fixture 17 of a machine spindle 18 of a machine tool. A tool 16 to be inserted can be removed from a storing location 19 of a non-illustrated tool magazine, for example, and can be inserted into the spindle holding fixture 17 of the machine spindle 18. The progress will be described subsequently based on FIGS. 5-8.

In the described embodiment the change device 15 is configured for automatic change of tools 16. Alternatively or additionally, the change device 15 can also be configured for change of workpieces.

In the embodiment the change device 15 has a gripper device 20 with at least one and according to the example, precisely two holders 21, each configured for holding or gripping one tool 16. By means of the gripper device 20, one tool 16 or two tools 16 can be gripped or held.

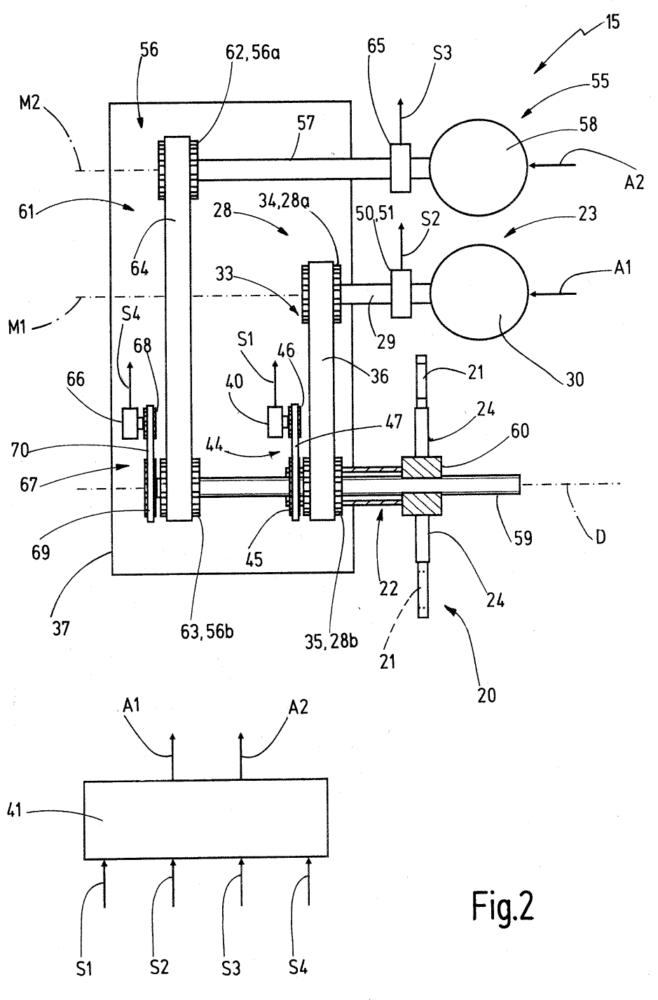

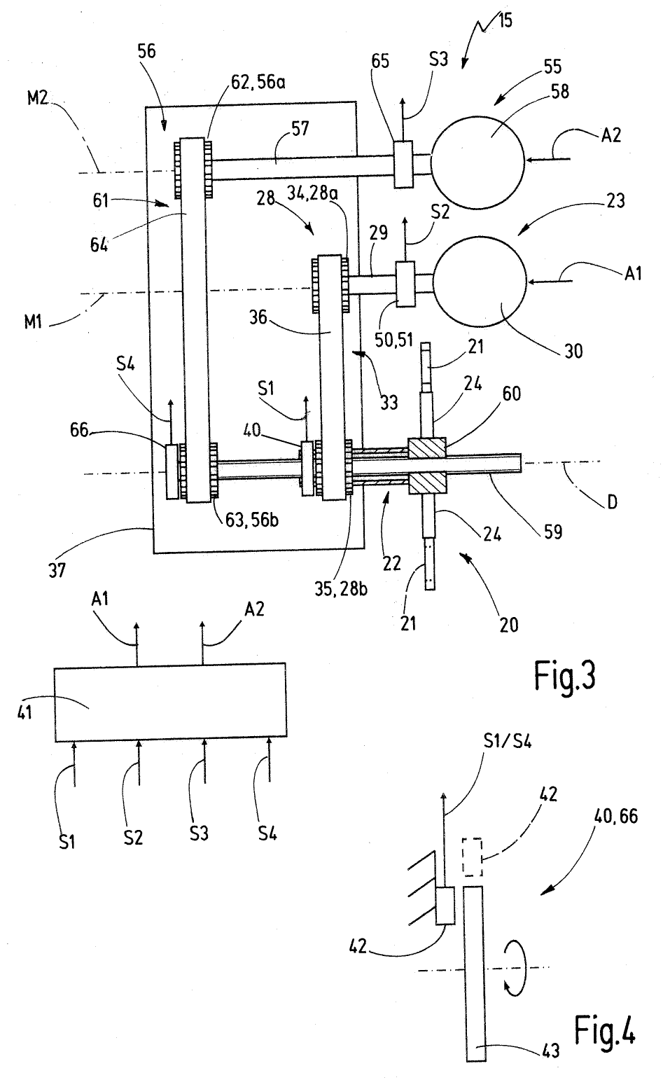

The gripper device 20 is arranged at a rotation support body 22 that is rotationally supported about a rotation axis D. The gripper device 20 can thus be rotated together with the rotation support body 22 about the rotation axis D. For executing the rotation movement of the gripper device 20 a rotary power train 23 is provided. Embodiments for the support of gripper device 20 and the configuration of the rotary power train 23 are illustrated in the block-diagram-like illustrations of FIGS. 2 and 3.

In the embodiment the gripper device 20 is configured as double gripper. It comprises two gripper arms 24 that extend originating from the rotation support body 22 in opposite directions. Each gripper arm 24 has a radial outer free end opposite the rotation axis D at which a holder 21 for one tool 16 is provided. In the embodiment the gripper arms 24 extend along a common straight line that is orientated orthogonal to the rotation axis D or radial to the rotation axis D. In a modification to the embodiment the number of gripper arms 24 or the number of holders 21 can be larger or lower.

The rotary power train 23 has a rotary drive transmission 28 with transmission input 28a and a transmission output 28b. In the embodiment the transmission output 28b of the rotary drive transmission 28 is connected in a torque-proof manner with the rotation support body 22. The transmission input 28a of the rotary drive transmission 28 is connected in a torque-proof manner with a first drive shaft 29 that is driven from a rotary drive motor 30 of the rotary power train 23. Thus, the rotary power train 23 establishes a driving connection between the rotary drive motor 30 and the rotation support body 22 via the rotary drive transmission 28.

In the embodiment the rotary drive transmission 28 comprises a first belt gear 33 and is formed by the first belt gear 33 in the embodiment. A first drive pulley 34 is connected in a torque-proof manner with the first drive shaft 29 and forms the transmission input 28a of the rotary drive transmission 28. A first output pulley 35 is connected in a torque-proof manner with the rotation support body 22 and forms the transmission output 28b of the rotary drive transmission 28. A first belt 36 connects the first drive pulley 34 with the first output pulley 35 in a torque-proof manner. The first belt 36 is configured as tooth belt and accordingly the first drive pulley 34 and the first output pulley 35 are configured as tooth belt discs.

The first belt gear 33 can provide an arbitrary ratio that can be smaller than 1, larger than 1 or equal to 1.

The rotary drive transmission 28 is arranged in a transmission housing 37. The first drive shaft 29 and the rotation support body 22 extend from the transmission housing 37. The first drive shaft 29 extends along a first motor axis M1 and can be rotationally driven about the first motor axis M1 by means of the rotary drive motor 30. In the embodiment the first motor axis M1 extends with distance to the rotation axis D. Preferably the first motor axis M1 is arranged vertically above the rotation axis D in the assembled condition of the change device 15.

The actual rotary position of the gripper device 20 or the gripper arms 24 about the rotation axis D is detected by a first rotary position sensor 40 that is configured to create a first sensor signal S1 characterizing the actual rotary position of the gripper device 20 or the gripper arms 24 about the rotation axis D and to submit the first sensor signal S1 to a control device 41. The control device 41 can create a first control signal A1 for control of the rotary drive motor 30 based at least on the first sensor signal S1 of the first rotary position sensor 40.

The first rotary position sensor 40 is coupled with the transmission output 28b and the rotation support body 22 without interconnection of the rotary drive transmission 28 and at least without interconnection of the belt gear 33. In doing so, the actual rotary position of the gripper device 20 about the rotation axis D can be detected and thus controlled by the control device 41 very precisely. The first rotary position sensor 40 can be coupled with the transmission output 28b of the rotary drive transmission 28 and the rotation support body 22 for detection of the rotary position of the gripper device 20 in a torque-proof manner or indirectly.

The first rotary position sensor 40 is arranged in the transmission housing 37 and thus protected from external influences, e.g. from interferences due to cooling media and/or chips in the machine tool.

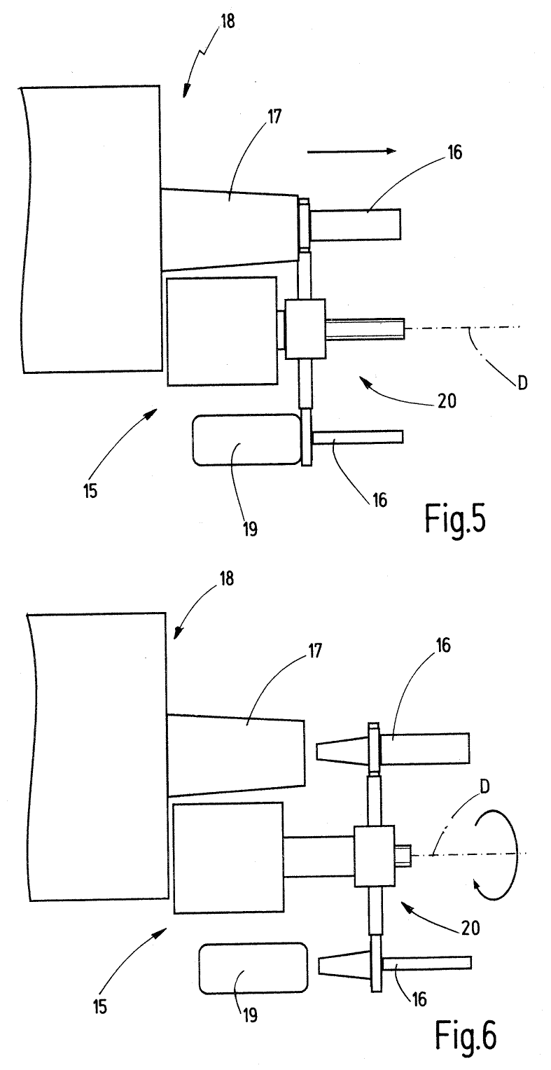

The configuration of a rotary position sensor that can be used as first rotary position sensor 40 is highly schematically illustrated in FIG. 4. The rotary position sensor comprises a non-rotating stationary sensor part 42, as well as a rotatable sensor part 43 that is rotatably supported relative to the stationary sensor part 42. The rotatable sensor part 43 is rotatingly movably coupled with the rotation support body 22. The rotatable sensor part 43 can be connected with the rotation support body 22 in a torque-proof manner and can rotate together with the rotation support body 22, as schematically illustrated in FIG. 3. Alternatively the rotatable sensor part 43 can be indirectly coupled with the rotation support body 22 via one or more coupling elements. In the embodiment shown in FIG. 2 the coupling between the rotatable sensor part 43 and the rotation support body 22 or the transmission output 28b can be realized via a first coupling gear 44. The first coupling gear 44 has a first coupling pulley 45 coupled with the rotation support body 22 and the transmission output 28b in a torque-proof manner and a second coupling pulley 46 coupled with the rotatable sensor part 43 in a torque-proof manner. The two coupling pulleys 45, 46 are rotationally movably coupled via a coupling belt 47. The coupling belt 47 is preferably configured as tooth belt.

Independent from the load to which the rotary power train 23 is subjected, the coupling of the first rotary position sensor 40 with the transmission output 28b and/or the rotation support body 22 is substantially load free. In doing so, the actual rotary position of the gripper device 20 about the rotation axis D can be detected very precisely.

As illustrated in FIGS. 2 and 3, the rotary power train 23 comprises an additional sensor 50. The additional sensor 50 is configured to create a sensor signal characterizing the rotary position or rotation movement of the first drive shaft 29 or the transmission input 28a of the rotary drive transmission 28 that is referenced here as second sensor signal S2. The second sensor signal S2 is submitted to the control device 41. According to the example, the additional sensor 50 is formed by a first motor sensor 51 that detects the rotary position of the rotary drive motor 30 about the first motor axis M1.

Thus, two separate sensor signals S1, S2 are provided to the control device 41 that depend from each other at least in the failure-free normal operation. In the normal operation during a rotation of the first drive shaft 29 about the first motor axis M1 the gripper device 20 rotates about the rotation axis D.

In a rotary power train with ideal configuration and without play and elasticities the second sensor signal S2 also characterizes the actual rotary position of the gripper device 20 about the rotation axis D. The two sensor signals 51, S2 have a defined fixed relation or dependency. In a real rotary power train 23 the rotary drive transmission 28 comprises play and/or elasticities. Particularly in the configuration according to the example with the first belt gear 33, a relation between the first sensor signal S1 and the second sensor signal S2 can vary with reference to the progression in time and/or with reference to the amount depending on the actual operating condition of the change device 15 or the rotary power train 23. This is particularly caused by the weight force of the one or the two tools 16 held by the gripper device 20, the weight force or weight forces of which cause a torque about the rotation axis D. This torque depends on the position of the gripper arms 24 relative to the horizontal or vertical and also from the weight of the one held tool 16 or from the weight difference of the two held tools 16. Dependent from this torque about the rotation axis D and the torque at the rotary drive motor 30, dynamic elasticities in the rotary drive transmission 28 are created that can have different amounts depending on the operating condition. Thus, the second sensor signal S2 does not necessarily correspond to the actual rotary position of the gripper device 20 about the rotation axis D. For this reason the first rotary position sensor 40 is coupled with the rotation support body 22 independent from the rotary drive transmission 28.

Because the control device 41 is provided with the first sensor signal S1 as well as the second sensor signal S2, the relation between the two sensor signals S1, S2 can be evaluated for providing additional information. For example, a rupture of the first belt 36 can be determined, because in this case the first sensor signal S1 does not change anymore depending on the rotation of the rotary drive motor 30. The actual rotary position of the gripper device 20 can no longer be influenced by the rotary drive motor 30. For example, the gripper device 20 can freely move about the rotation axis D in case of a rupture of the first belt 36 until it takes a balanced position—at least if no self-locking effect impedes the free movement.

The first sensor signal S1 and the second sensor signal S2 can be used additionally or alternatively also to determine the weight or the weight difference of a tool 16 or two tools 16 held in the gripper device 20. For example, the gripper device 20 can be moved in a defined rotary position about the rotation axis D that is defined by the second sensor signal S2. The elasticity in the rotary power train 23 is responsible that the actual rotary position characterized by the first sensor signal S1 does not necessarily correspond to the defined desired rotary position characterized by the second sensor signal S2. The larger the deviation, the larger the weight of a tool held in the gripper device 20. If two tools 16 are held in the gripper device 20, the weight difference can be determined. Preferably, the gripper device 20 is orientated horizontally for determination of the weight, i.e. the gripper arms 24 extend parallel to a horizontal plane. In order to calibrate the weight determination by the control device 41, one or more tools 16 or other bodies can be arranged in the gripper device 20 one time. In doing so, function, a characteristic curve or a characteristic map can be determined and stored such that subsequently a weight determination is possible also for other tools 16.

If the weight of a tool 16 or weights of tools 16 are known that are stored in a tool magazine of the machine tool, the weights can be considered by the control device 41 for the control of the rotary drive motor 30. Because in this case also the resulting torque and inertia moment about the rotation axis D resulting therefrom are known. The torque of the rotary drive motor 30 can be controlled according to a time-dependent progress in order to achieve a positioning and feedback control of the rotary position of the gripper device 20 about the rotation axis D as quick as possible. In doing so, a required duration for a tool change in a machine tool can be minimized. In addition, vibrations and oscillations of the rotation movement of the gripper device 20 about the rotation axis D can be avoided or minimized.

In the embodiment the change device 15 also comprises a shift power train 55. The shift power train 55 is configured to move the gripper device 20 along or parallel to the rotation axis D and thus to initiate a shift movement. In the embodiment the shift power train 55 comprises a shift drive transmission 56 having a transmission input 56a and a transmission output 56b. The transmission input 56a of the shift drive transmission 56 is connected with a second drive shaft 57 in a torque-proof manner. The second drive shaft 57 can be driven by a shift drive motor 58. The transmission output 56b of the shift drive transmission 56 is connected with a threaded spindle 59 in a torque-proof manner along which a spindle nut 60 is shiftably supported. For this the spindle nut 60 is locked against a rotation movement about the rotation axis D. The threaded spindle 59 extends along the rotation axis D. The spindle nut 60 is immovably connected with the rotation support body 22 and can thus neither rotate relative to the rotation support body 22, nor move along the rotation axis D relative to the rotation support body 22. The spindle nut 60 can be part of the rotation support body 22 that can be configured as a single part or as an assembly of multiple parts.

The shift drive transmission 56 comprises a belt gear that is referenced as second belt gear 61 in order to distinguish from the first belt gear 33 of the rotary drive transmission 28. Preferably the shift drive transmission 56 is formed by the second belt gear 61. The second belt gear 61 has a second drive pulley 62 that forms the transmission input 56a and a second output pulley 63 that forms the transmission output 56b. The second drive pulley 62 and the second output pulley 63 are rotationally movably coupled by a second belt 64. The second belt 64 is preferably configured as tooth belt.

The second drive shaft 57 can be rotationally driven about the second motor axis M2 by the shift drive motor 58. The second motor axis M2 is preferably parallel to the rotation axis D and/or the first motor axis M1 and further preferably arranged vertically above the rotation axis D. The second motor axis M2 can be arranged vertically above the first motor axis M1. The control device 41 is configured to create a second control signal A2 for control of the shift drive motor 58. In the embodiment a second motor sensor 65 is provided analog to the rotary power train 23, wherein the second motor sensor 65 creates a third sensor signal S3 that characterizes the rotary position of the second drive shaft 57 or the transmission input 56a of the shift drive transmission 56 and submits the third sensor signal S3 to the control device 41. The third sensor signal S3 is characteristic for the shift position of the gripper device 20 along the rotation axis D. Because load-dependent deviations due to an elasticity of the shift drive transmission 56 are not relevant or do not have a decisive impact, the position of the gripper device 20 along the rotation axis D can be determined at the transmission input 56a of the shift drive transmission 56.

In order to allow the shift movement of the gripper device 20 along the rotation axis D, the rotation support body 22 including the spindle nut 60 is connected with the first output pulley 35 or the transmission output 28b of the rotary drive transmission 28 in a torque-proof manner and can be shifted parallel to the rotation axis D. Due to a rotation of the threaded spindle 59, a shift movement can be caused.

The shift power train 55 further comprises a second rotary position sensor 66 that is assigned to the transmission output 56b of the shift drive transmission 56 and is coupled therewith. The second rotary position sensor 66 creates a fourth sensor signal S4 that is characteristic for the rotary position or the rotation movement at the transmission output 56b of the shift drive transmission 56 and according to the example, for the rotation movement of the threaded spindle 59 and/or the second output pulley 63 about the rotation axis D.

Thus, also for the shift drive transmission 56 or the shift power train 55 a third sensor signal S3 characterizing the rotation movement at the transmission input 56a and a fourth sensor signal S4 characterizing the rotation movement at the transmission output 56b are provided to the control device 41. Thus, the control device 41 is able to determine deviations, due to failures in the shift drive transmission 56. For example, a belt rupture of the second belt 64 in the second belt gear 61 can be determined.

The second rotary position sensor 66 can have the configuration shown in FIG. 4 analog to the first rotary position sensor 40.

In the embodiment shown in FIG. 2 the second rotary position sensor 66 is coupled with the threaded spindle 59 in a manner similar to the coupling of the first rotary position sensor 40 with the rotation support body 22. Specifically a second coupling gear 67 is provided for this with a third coupling pulley 68 that is coupled with the rotatable sensor part 43 of the second rotary position sensor 66 in a torque-proof manner. A fourth coupling pulley 69 is connected with the threaded spindle 59 in a torque-proof manner. The third and fourth coupling pulleys 68, 69 are movably coupled by a second coupling belt 70 of the second coupling gear 67. The second coupling belt 70 is preferably configured as tooth belt.

Alternatively to this coupling of the second rotary position sensor 66 with the threaded spindle 59, the second rotary position sensor 66 can also be arranged on the level of the rotation axis D. The rotatable sensor part 43 of the second rotary position sensor 66 can then be connected with the threaded spindle 59 or the transmission output 56b of the shift drive transmission 56 indirectly or directly in a torque-proof manner (FIG. 3).

The embodiments shown in FIGS. 2 and 3 can be combined with each other. For example, one of the rotary position sensors 40, 66 can be coupled via the respective coupling gear 44 or 67 respectively and the respective other rotary position sensor 66 or 40 can be arranged on the level of the rotation axis D and can be torque-proof connected with the rotation support body 22 or the threaded spindle 59 respectively.

The shift drive transmission 56 is arranged in the transmission housing 37. The transmission housing 37 is thus configured as common transmission housing for the rotary drive transmission 28 and the shift drive transmission 56.

It has to be noted that the shift movement of the gripper device 20 along or parallel to the rotation axis D and the rotation movement of the gripper device 20 about the rotation axis D can also be effected by other mechanical means.

The change device 15 described so far can execute an automatic tool change as subsequently described with reference to FIGS. 5-10.

In FIG. 5 an initial situation is schematically illustrated, wherein a tool 16 is present in the spindle holding fixture 17 that shall be exchanged by another tool 16 that is arranged in the storing location 19 of a tool magazine that is not shown. The change device 15 is positioned between the storing location 19 and the spindle holding fixture 17, such that the gripper device 20 is able to grip the tool 16 provided in the spindle holding fixture 17, as well as the tool 16 provided at the storing location 19 by means of a rotation movement about the rotation axis D (FIG. 5). Subsequently by a shift movement of the gripper device 20 along the rotation axis D the tool 16 is removed from the spindle holding fixture 17 and the tool 16 to be inserted is removed from the storing location 19. The situation resulting therefrom is illustrated in FIG. 6.

The tools 16 held by the gripper device 20 are released and the gripper device 20 can rotate about the rotation axis D. Subsequently, the tool 16 to be inserted is located in front of the spindle holding fixture 17 and the removed tool 16 is located in front of the storing location 19. Then by a shift movement of the gripper device 20 along the rotation axis D the removed tool 16 can be arranged at the storing location 19 and the tool 16 to be inserted can be arranged in the spindle holding fixture 17 (FIG. 7).

After this tool exchange the tools 16 are released by the gripper device 20 and the gripper device 20 can rotate about the rotation axis D, e.g. by an amount of about 90° (FIG. 8). Subsequently the change device 15 and/or the tool magazine or the storing location 19 can be moved away such that the working space of the machine tool is ready for machining of a workpiece.

The invention refers to a change device 15 for changing or exchanging of tools 16 and/or workpieces. The change device 15 has a gripper device 20 with at least one gripper arm 24 that extends away from a rotation support body 22 that is rotatably supported about the rotation axis D and that has a holder 21 for respectively one tool 16 or one workpiece at its free end. By means of a rotary power train 23 with a rotary drive motor 30 and a rotary drive transmission 28, the gripper device 20 can be rotated about the rotation axis D. Particularly the rotary drive transmission 28 has a belt gear 33. A first rotary position sensor 40 is directly or indirectly coupled with the rotation support body 22 and/or transmission output 28b of the rotary drive transmission 28 without interconnection of the rotary drive transmission 28 for detection of the rotary position of the gripper device 20 about the rotation axis D.

### LIST OF REFERENCE SIGNS

15 change device
16 Tool
17 spindle holding fixture
18 machine spindle
19 storing location
20 gripper device
21 Holder
22 rotation support body
23 rotary power train
24 gripper arm
28 rotary drive transmission
28a transmission input of the rotary drive transmission
28b transmission output of the rotary drive transmission
29 first drive shaft
30 rotary drive motor
33 first belt gear
34 first drive pulley
35 first output pulley
36 first belt
37 transmission housing
40 first rotary position sensor
41 control device
42 stationary sensor part
43 rotatable sensor part
44 coupling gear
45 first coupling pulley
46 second coupling pulley
47 first coupling belt
50 additional sensor
51 first motor sensor
55 shift power train
56 shift drive transmission
56a transmission input of the shift drive transmission
56b transmission output of the shift drive transmission
57 second drive shaft
58 shift drive motor
59 threaded spindle
60 spindle nut
61 second belt gear
62 second drive pulley
63 second output pulley
64 second belt
65 second motor sensor
66 second rotary position sensor
67 second coupling gear
68 third coupling pulley
69 forth coupling pulley
70 second coupling belt
A1 first control signal
A2 second control signal
D rotation axis
M1 first motor axis
M2 second motor axis
S1 first sensor signal
S2 second sensor signal
S3 third sensor signal
S4 fourth sensor signal

What is claimed is:

1. A change device that is configured for changing tools and/or workpieces, comprising:
a gripper device that is rotatably supported about a rotation axis at a rotation support body, the gripper device having at least one holder for a tool and/or a workpiece to be held,
a rotary power train that is configured to rotate the gripper device about the rotation axis,
wherein the rotary power train comprises a rotary drive motor and a rotary drive transmission, wherein the rotary drive motor is drivingly coupled with a transmission input of the rotary drive transmission and wherein transmission output of the rotary drive transmission is drivingly connected with the rotation support body,
a first rotary position sensor that is coupled with the rotation support body without interconnection of the rotary drive transmission, wherein the first rotary position sensor is configured to detect a rotary position of the gripper device about the rotation axis.

2. The change device according to claim 1, wherein the rotary drive transmission comprises a first belt gear.

3. The change device according to claim 1, wherein the first rotary position sensor is coupled with the rotation support body in a torque-proof manner.

4. The change device according to claim 1, wherein the first rotary position sensor is coupled with the rotation support body via at least one coupling element in a non-torque-proof manner.

5. The change device according to claim 4, wherein the coupling element is a coupling belt.

6. The change device according to claim 1, wherein a control device is provided and a sensor signal of the first rotary position sensor is submitted to the control device and control device is configured to control the rotary drive motor.

7. The change device according to claim 6, wherein the rotary power train comprises an additional sensor that is configured to create a sensor signal corresponding to a rotary position of the transmission input and wherein the sensor signal of the additional sensor is submitted to the control device.

8. The change device according to claim 7, wherein the additional sensor is a motor sensor that is configured to detect a rotary position of the rotary drive motor about a motor axis of the rotary drive motor and the motor sensor submits a sensor signal corresponding to the rotary position of the rotary drive motor to the control device.

9. The change device according to claim 7, wherein the control device is configured to determine a mass of the tool or workpiece that is held in the at least one holder.

10. The change device according to claim 7, wherein the rotary drive transmission comprises a first belt gear and the control device is configured to determine a rupture of a belt of the first belt gear.

11. The change device according to claim 1, further comprising: a shift power train configured to move the gripper device along the rotation axis.

12. The change device according to claim 11, wherein the shift power train comprises a shift drive transmission having a transmission input and a transmission output, a shift drive motor drivingly coupled with the transmission input and a threaded spindle having a spindle nut, wherein the threaded spindle is drivingly coupled with the transmission output of the shift drive transmission.

13. The change device according to claim 12, wherein a control device is provided and a sensor signal of the first rotary position sensor is submitted to the control device and the control device is configured to control the rotary drive motor and a second rotary position sensor, the second rotary position sensor being coupled with the threaded spindle without interconnection of the shift drive transmission , the second rotary position sensor creates a sensor signal for determining rotation movement and/or rotary position of the threaded spindle about the rotation axis and the second rotary position sensor submits the sensor signal to the control device.

14. The change device according to claim 12, wherein a control device is provided and a sensor signal of the first rotary position sensor is submitted to the control device and the control device is configured to control the rotary drive motor and wherein the shift power train comprises a motor sensor that is creates a sensor signal for determining a rotary position of the transmission input of the shift drive transmission and the motor sensor submits the sensor signal to the control device.

15. The change device according to claim 12, wherein the shift drive transmission comprises a second belt gear.

16. The change device according to claim 15, wherein the control device is configured to determine a rupture of a belt of the second belt gear.

17. The change device according to claim 12, wherein the spindle nut is immovably connected with the rotation support body or is an integral part of the rotation support body.

18. The change device according to claim 12, wherein the spindle nut is supported in a torque-proof manner relative to the transmission output of the rotary drive transmission.

19. The change device according to claim 1, wherein the rotary drive transmission comprises a transmission housing in which the first rotary position sensor is arranged.

20. The change device according to claim 19, wherein the rotary drive transmission comprises a transmission housing in which the first rotary position sensor is arranged and the second rotary position sensor is arranged in the transmission housing.

21. The change device according to claim 1, wherein the gripper device comprises at least one gripper arm extending away from the rotation support body orthogonal to the rotation axis, wherein the gripper arm has at its free end opposite the rotation support body a holder for the tool and/or the workpiece.
